(19) United States
(12) Patent Application Publication
(10) Pub. No.: US 2018/0130155 A1
(43) Pub. Date: May 10, 2018

(54) Systems and Methods for Simultaneously Visualizing Academic and Career Interrelationship Arrays

(71) Applicants: Adeboyejo Adetokunbo Oni, Bethesda, MD (US); Patrick Schlafer, Rockville, MD (US); John R. Tegen, North Potomac, MD (US)

(72) Inventors: Adeboyejo Adetokunbo Oni, Bethesda, MD (US); Patrick Schlafer, Rockville, MD (US); John R. Tegen, North Potomac, MD (US)

(21) Appl. No.: 15/348,943

(22) Filed: Nov. 10, 2016

(51) Int. Cl. G06Q 50/20; G06F 17/30

(52) U.S. Cl. CPC G06Q 50/2053; G06F 17/30604

(57) ABSTRACT

Unique visuals are presented to a user to allow the user to simultaneously view and understand a plurality of academic and career paths. Each visual comprises an array of element types (e.g., academic institutions, academic majors, occupations or jobs). The visuals permit a user to simultaneously see the interrelationships between many different elements related to a multitude of academic and career paths.

### RELATED APPLICATIONS

This application is related to U.S. patent application Ser. No. 14/883,424 (the “'424 Application”) filed Oct. 14, 2015, U.S. patent application Ser. No. 15/081,290 filed Mar. 25, 2016 (the “'290 Application”), U.S. patent application Ser. No. 15/209,725 filed Jul. 13, 2016 (the “'725 Application”), U.S. patent application Ser. No. 15/267,501 filed Sep. 16, 2016 (the “'501 Application) and U.S. patent application Ser. No. 10/657,562 (the “'562 Application”) now U.S. Pat. No. 7,299,217 and incorporates by reference herein the entire disclosures, both text and drawings, of the '424, '290, '725, '501 and '562 Applications as if set forth in full herein.

### INTRODUCTION

The educational and career path considered by an individual typically includes consideration of a number of interrelated elements, such as academic institutions, the majors offered by such institutions and the occupations and jobs related to such majors.

Consideration of each one of these elements is necessary, but not sufficient by itself, to enable an individual to reach a tangible goal. In considering an educational or career path, the individual typically reviews the attributes of each element independently of the other elements, even though each element is deeply interconnected and related to one another at many levels: there are associations, dependencies and non-dependencies. While there exists some services or tools, such existing services do not permit an individual to perform an in-depth review of a plurality of interrelated elements at the same time.

Accordingly, it is desirable to provide systems and methods that improve upon the technology that allows an individual to perform an in-depth review of the interrelationships among an array of educational and career elements.

It is further desirable to provide similar systems and methods for allowing an individual to perform an in-depth review of the interrelationships among an array of elements by simultaneously presenting such interrelationships visually.

It is further desirable to instantly present such visuals to a user.

### SUMMARY

In accordance with the present invention, embodiments of inventive systems and methods are provided that permit interrelated arrays of elements, where, for example, the arrays are associated with academic and career decisions and paths, to be simultaneously visualized by a user.

Though this summary is intended to summarize the embodiments described herein, it should be understood that variations of the summarized embodiments may be made without departing from the spirit of the invention. For example, additional embodiments besides those related to education and career paths are covered by the present invention. In general, the teachings of the present invention may be used where there are many interrelated elements that are a part of a path.

In one embodiment the present invention provides for a system for visualizing interrelationships in academic or career paths comprising: a hardware platform operable to, generate data, representing one or more visuals, based on a relationship map (e.g., a scientifically valid relationship map) that comprises interrelationships between a plurality of element types related to one or more academic or career paths; and send the generated data to a user device, wherein the one or more visuals permits a user of the user device to simultaneously visualize the interrelationships between the many element types related to the one or more academic or career paths. Each element type may further comprise a plurality of elements, wherein each element of a same element type shares a minimum number of similar attributes. Accordingly, such a platform may be operable to generate such data representing one of the one or more visuals, where the data represents an array of element types. The so generated data may further comprise data representative of image, textual, animation, video, or graphical information associated with one or more of the plurality of elements, while the plurality of element types may comprise academic institutions, academic majors, occupations and jobs to name just a few of the many different element types.

In an additional embodiment, the one or more of the elements of an element type comprises one or more sub-elements.

One or more of the visuals may further comprise a plurality of links connecting at least one of the elements or sub-elements of one of the element types to at least one element or sub-element of another element type, wherein the link represents interrelationships between the connected elements or sub-elements. In turn, links may form a path (e.g., academic or career path).

In addition to a platform, systems provided by the present invention may further comprise a user device that is operable to receive data from the platform, where the data represents a relationship map, and is used by the user device to has been and then display the data as one or more visuals.

Yet further, either the platform or user device may be operable to change a configuration of an array. The changed array may comprise corresponding changes to interrelationships between the many element types related to the one or more academic or career paths, for example. More particularly, the platform (or user device) may be further operable to change a configuration of one or more of the visuals by changing a position /or sequence of element types within the element types, or to change the map and the one or more visuals based on reference data related to a time or time period.

In addition to the systems described above, and elsewhere hereon, the present invention also provides for related methods for visualizing interrelationships in academic or career paths. One such method may comprise: generating data, by a hardware platform, representing one or more visuals, based on a relationship map (e.g., a scientifically valid relationship map) that comprises interrelationships between many element types (e.g., academic institutions, academic majors, occupations and jobs) related to one or more academic or career paths, and sending the generated data to a user device from the hardware platform, wherein the one or more visuals permits a user of the user device to simultaneously visualize the interrelationships between the many element types related to the one or more academic or career paths.

As described before, each element type in such a method may further comprise a plurality of elements, wherein each element of a same element type shares a minimum number of similar attributes, and the so generated data may further comprise data representative of image, textual, animation, video, or graphical information associated with one or more of the plurality of elements.

Further, each of the elements may comprises one or more sub-elements.

The visuals produced by the method may further comprise a plurality of links connecting at least one of the elements or sub-elements of one of the element types to at least one element or sub-element of another element type, wherein the link represents interrelationships between the connected elements or sub-elements. Together or collectively, such links may form a path (e.g., an academic or career path).

An associated or alternative method may involve a user device, where data sent from the platform is received at a user device and then used by the device to display one or more visuals on the user device or another display. Again, the so generated data may represent one or more visuals comprising an array of element types.

The inventive method(s) may further comprise changing a configuration of an array, where the changed array comprises corresponding changes to interrelationships between many element types related to one or more academic or career paths, for example. Such changes may be made by a platform of user device. The configuration of one or more of the visuals may be changed by changing a position/or sequence of element types within the element types using the platform.

An additional or supplemental method may further comprise changing a relationship map and one or more corresponding visuals based on reference data related to a particular time or time period using the platform.

### BRIEF DESCRIPTION OF THE DRAWINGS

FIG. 1 depicts a block diagram of an exemplary system according to one or more embodiments of the present invention.

FIGS. 2 through 5 depict exemplary visuals in accordance with one or more embodiments of the present invention.

### DETAILED DESCRIPTION, WITH EXAMPLES

Exemplary embodiments of systems and methods for simultaneously and instantly visualizing the interrelationships between academic and career elements are described herein. Although specific exemplary embodiments are discussed herein, there is no intent to limit the scope of the present invention to such embodiments. To the contrary, the exemplary embodiments discussed herein are for illustrative purposes. Modified and alternative embodiments may be implemented without departing from the scope of the present invention. Said another way, the exemplary embodiments presented herein are only some of the many that fall within the scope of the present invention, it being practically impossible for the inventor to describe all the many possible exemplary embodiments and variations that fall within the scope of the present invention.

For example, though the systems and methods described herein focus on applying the inventive systems and methods to education and careers, this is for illustrative purposes only, it being further understood that the systems and methods may be applied to other types of services such as healthcare, to name just one of the many additional types of services that the inventive systems and methods maybe applied to.

When the description herein describes the use of a “hardware platform” such a platform may include one or more devices. For example, the devices may comprise one or more hardware servers, as well as one or more processors, memories, caches and databases. The servers and processors may be operable to execute stored, specialized instructions for completing features and functions described herein. Such instructions may be stored in an onboard memory, in separate memory, or in a specialized database for example. Such instructions represent functions and features that have been integrated into memory as stored electronic signals.

It should also be understood that one or more exemplary embodiments may be described as a process or method. Although a process/method may be described as sequential, such a process/method may be performed in parallel, concurrently or simultaneously. In addition, the order of each step within a process/method may be re-arranged. A process/method may be terminated when completed, and may also include additional steps not included in a description of the process/method.

Yet another phrase is “user”. As used herein a user is an individual that exchanges information with systems, devices and platforms provided by the present invention. Exemplary non-limiting examples of a user are a student, parent of a student, or a guidance counselor, another advisor advising a student, an individual in the work force, or an individual desiring to enter the work force (i.e., become employed). Similarly, the phrase “user device” means a device used by such a user. The phrases “user” and “user device” as used herein may be used synonymously unless the context of the usage, or common sense, dictates otherwise.

As used herein, the term “and/or” includes all combinations of one or more of the associated listed items. As used herein, the singular forms “a,” “an” and “the” are intended to include the plural form, unless the context and/or common sense indicates otherwise. It should be further understood that the terms “comprises”, “comprising,”, “includes” and/or “including”, when used herein, specify the presence of stated features, systems, subsystems, steps, operations, elements, and/or components, but do not preclude the presence or addition of one or more other features, systems, subsystems, steps, operations, elements, components, and/or combinations thereof.

As used herein, the designations “first”, “second”, “third”, etc., is purely to distinguish one component (e.g., element type, element, app, device, subsystem, section, etc.,) or part of a process from another and does not indicate an importance, priority or status. In fact, the component or parts of a process could be re-designated (i.e., re-numbered) and it would not affect the operation of systems or methods provided by the present invention.

As used herein the phrases “connection”, “connected to”, or similar phrases means an indirect or direct physical connection between at least two different parts of a platform, device, system, or generated and visualized relationship map (visual), or means one part of a platform, device, system or visual is subsumed within (and thereby connected to) at least one other part of a platform, device, system or visual. When one part of a platform, device, system or visual is described or depicted as being connected to another part, other well-known components used to facilitate such a connection may not be described or depicted because such components are well known to those skilled in the art.

Yet further, when one part of a platform, device, system or visual is described or depicted as being connected to another part using “a connection” (or single line in a figure) it should be understood that practically speaking such a connection (line) may comprise (and many times will comprise) more than one physical connection or channel, may be omni-directional or bi-directional, may or may not include separate data, formatting and signaling, and, in the case of a visual that is depicting interrelationships between elements in an array representative of a relationship map, a connection represents a relationship between attributes of so-connected elements.

Still further, a system or device (e.g., user device) that completes features and functions of embodiments of the invention may include a web browser that is a part of an interface or one or more applications (often referred to herein as an “app” or “apps”) that have been installed into, or downloaded onto, a system or device. An “app” may include “content” (e.g., text, audio and video files), signaling and configuration files. For the sake of convenience and not limitation, the terms “app” or “application” are used herein to refer to any application, but use of such a term also includes a reference to any file or data.

In one embodiment, an app to be downloaded onto a user device may also reside or be stored on one or more hardware devices, such as a server in whole and/or in part, the later indicating that the app may be distributed among, and by, several devices (servers). An app may be downloaded to a user device from an app server (or servers) or have been otherwise provided and installed on such a server. A given user device may have a need for one or more of the apps installed on a server. Accordingly, each of the embodiments described herein includes protocols, necessary hardware, software and firmware resident on a user device for transmitting and receiving (i.e., “transceiving”) an app, content and/or content identification information relating to the app from/to a server and vice-versa. Depending on the content to be transmitted, an app may be installed directly on a user device or may be downloaded from a server by initiating a request to a server to receive a local copy of the app. When a discussion herein describes the sending and reception of data (i.e., transmissions and receptions) from/to a user device to/from a platform a web browser and/or app may be used to complete such transmissions and receptions.

It should further be understood that the platforms, systems and devices described herein may include the ability for a third party or a user to access all, or some, of the functionality of the platforms, systems and devices described herein using, for example, an application programming interface (API). In general, an API is a set of subroutine definitions, protocols, and tools that the platforms, systems and devices described herein provide to enable users and third parties to build connections to the platforms, systems and devices described herein as well create their own software and applications. More particularly, the platforms, systems and devices described herein may provide APIs that are suitable for a web-based system, operating system, database system, computer hardware, or software library. The API may include a specification, including, but not limited to, routines, data structures, object classes, variables, or remote calls. POSIX, Microsoft Windows API, the C++ Standard Template Library, and Java.

It should be noted that the platforms, systems, devices and visuals illustrated in the figures are not drawn to scale, are not representative of an actual shape or size and are not representative of any actual system, platform, device layout, manufacture's drawing or visual. Rather, the platforms, systems, devices and visuals are drawn to simply help explain the features, functions and processes of exemplary embodiments of the present invention described herein and covered by the claims set forth at the end of this description.

As used herein the phrases “education” and “academic” may be used interchangeably.

As used herein, the term “embodiment” refers to one example of the present invention.

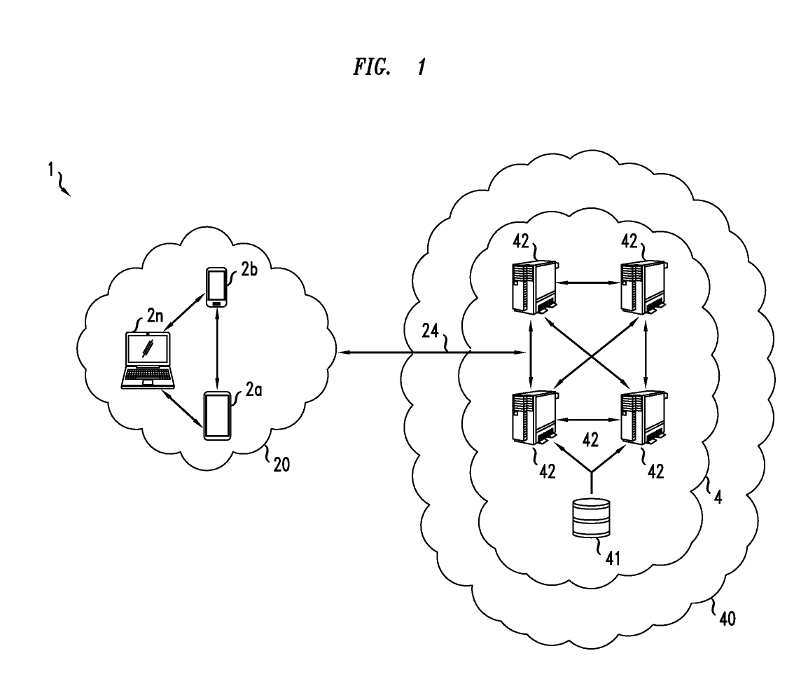

Turning now to FIG. 1, there is depicted a block diagram of an overall system 1 that represents an improvement in the technology that allows an individual user (user) to view the many interrelationships between, and among, academic and career element types by simultaneously and instantly visualizing such relationships.

As shown in FIG. 1, the system 1 may comprise a network, hardware platform 4 that is a part of a first network 40, and user devices 2a, 2b, . . . 2n (where “n” represents the last user device) that is a part of a second network 20. Other components may be included in the system 1, but presently these components and their respective functions are believed to be well known by those skilled in the art, and, therefore, for the sake of clarity their description will be omitted.

The platform 4 and each of the devices 2a, 2b, . . . 2n may be part of different networks 40, 20 respectively or may be part of the same network. Each of the devices 2a may comprise a wired or wireless device, a desktop computer, a laptop computer, tablet, phablet, hand-held device, terminal, a virtual machine, or server to name just a few examples. Such devices may be located locally or remotely from the platform 4.

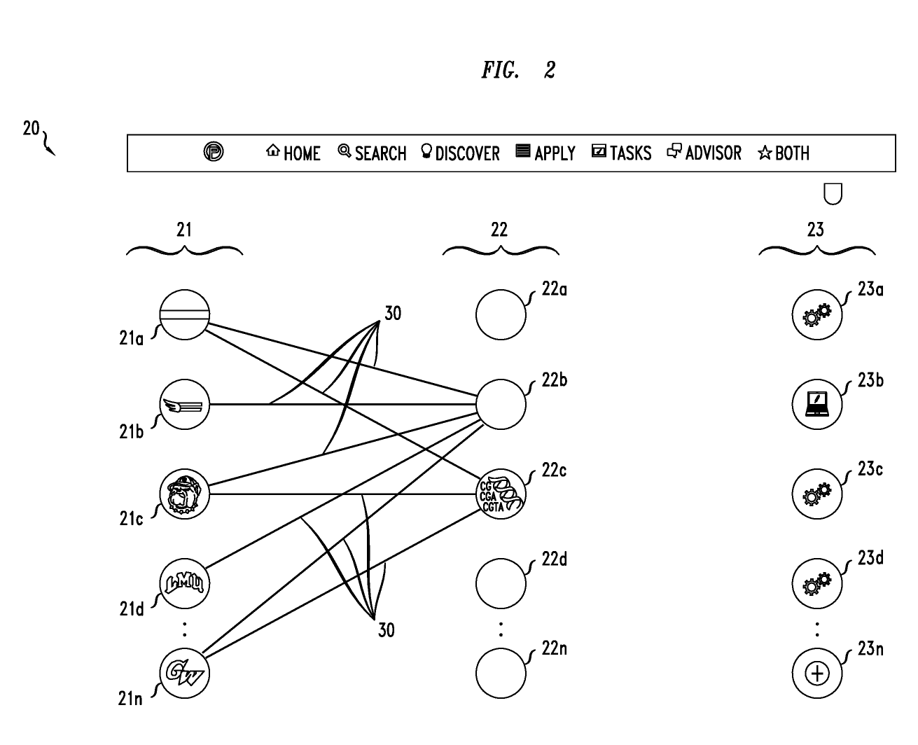

In an exemplary embodiment, the devices 2a, 2b, . . . 2n may comprise the necessary hardware and software for completing all the functions and features described herein. For example, hardware for connecting them to the platform 4 and network 40 via wired or wireless means known to those skilled in the art, and hardware and software for receiving data from, and transmitting data to, platform 4 and hardware and software for displaying the visuals depicted in FIGS. 2 through 5, where it is understood that any software is electronically stored on hardware and accessed as needed to complete the features and functions described herein.

It should be understood that a service or services provided by the platform 4 to a user device 2a, 2b, . . . 2n and therefore, to a user, (distinct from services provided by an institution or service provider) may be an “on demand”, real-time service, or, alternatively may comprise a free service, a combination of a free service and a premium service (“freemium” service for short), or still further, may comprise a subscription service. In one embodiment, a user of device 2a, 2b, . . . 2n (hereafter, collectively referred to as simply “user device 2a) may access platform 4 provided the user has been granted access to such free or “freemium” services, or has been granted access to subscription-based services after providing payment (using an app, for example). Platform 4 may comprise a communications hub (not shown in FIG. 1) operable to provide web-based services, and exchange communications with a user of device 2a order to grant, or deny, the user access to platform 4 (or specific freemium and subscription functions and features (i.e., services) provided by the platform 4) using one or more authentication and registration processes known in the art. Alternatively, such communications may be exchanged between a user device and a third party registration system in order to grant, or deny, the user device 2a and an associated user access to specific freemium and subscription functions and features (i.e., services) provided by the platform 4.

In addition to the specific features and functions discussed in more detail below, the platform 4 and/or devices 2a, 2b, . . . 2n may comprise the necessary hardware and software for completing at least the following functions: completing one or more academic or career oriented assessments, generating data representative of a relationship map (described below), exchanging the generated data, displaying visuals that include an array of elements (also described below, changing a configuration of the array, tracking a user's status as a paid user (subscriber) or freemium user, updating a relationship map over time, tracking the features and services provided by the platform 4 that have been selected by a user as a freemium or paid user, completing e-commerce transactions (e.g., payment for subscription services), providing customer support features (e.g., help desk, technical support, billing inquiries, etc.), social networking linkage (e.g., to Face book, Twitter, other accounts), those functions required to support communications (e.g., notifications) via one or more apps, and those functions needed to communicate with a third party service provider.

Device 2a may include an interface. Some non-limiting examples of such an interface are a graphical user interface (GUI), web browser, keyboard, touch screen, display, voice recognition system, an interface used by disabled individuals, or some combination of such devices, to name but a few of the many examples of an interface. The interface may be used to exchange communications with the platform 4 or another device via a web browser or an app, for example. Each interface may comprise the necessary electronics (such as one or more processors) specially designed and programmed to complete the features and functions described herein by, for example, accessing integrated instructions stored in memory and/or data stored in memory.

In one embodiment, the platform 4 may be a part of a network 40. The network 40 may be a wired or wireless network, such as the Internet, an Intranet, secure network, 3G, 4G, 5G or more advanced network, local area network (LAN), or wide area network (WAN) to name just a few of the many types of networks. Yet another example, platform 4 may comprise a plurality of hardware servers that are part of a cloud-based data center or data centers. Still another example, platform 4 may comprise a plurality of virtual machines stored on a hardware server or computer, for example.

While the overall platform 4 is shown in FIG. 1 as including four servers 42 this is merely exemplary. Alternatively, the platform 4 may comprise fewer servers or more servers. Yet further, the functions completed by each server 42 making up the platform 4 may be distributed, that is, the functions may be separated into individual or grouped functions that are completed by separate servers that may, or may not be, co-located.

Alternatively, platform 4 may comprise one or more processors 42 specially designed and programmed to complete the features and functions described herein by, for example, accessing instructions stored in memory and/or or a database. Similarly, platform 4 may comprise several subsystems 42. Each of these subsystems 42 may comprise one or more processors specially designed and programmed to complete the features and functions described herein by, for example, accessing instructions stored in memory and/or a database. It should be understood, however, that depending on the feature or function, each of the subsystems 42 need not necessarily include a processor, memory and a database.

In embodiments of the invention, rather than be “always on” each function, feature or subsystem may be configured on a “just in time” basis singularly, or in relation to one another, so that each is activated (i.e., “turned on”) only as needed to provide the functionality required to provide a capability (e.g., utility) or service. Examples of such utilities include, but are not limited to “notification” and “binder” utilities. In one embodiment, a notification utility generates notifications or messages that may be sent to, or from, a user device. Such notifications may be part of an associated service, for example.

The platform 4 may include one or more databases 41 operable to store information in the form of text, audio, video, image or some combination of such information in a plurality of desired formats for ease of storage, retrieval and eventual usage by the platform and devices described herein. For example, in an embodiment of the invention, the platform 4 may be operable to provide content within databases 41 to a device 2a as part of a content-as-a-service. Such a service may be provided to a user of a device 2a as a standalone service or may be combined with other information and provided to a user of a device 2a where it may be displayed to a user via an interface. Such a content-as-a-service may be combined with one or more other services described herein. Further, content exchanged between the platform 4 and any of the user devices described herein may need to be compressed or decompressed upon transmission or reception to insure an acceptable or high level of data transfer and performance. When required, compression/decompression of content may be performed by one or more techniques known to those skilled in the art.

In one embodiment of the invention, servers 42 may be operable to select certain content from databases 41, such as scientifically valid user assessment information, academic accomplishments, skills and capabilities, user preferences, a user profile and user identity (collectively “user data”), detailed information about a number of different types of academic institutions, academic majors, occupations, jobs (and the varied attributes associated with the institutions, majors, occupations and jobs) (collectively “attribute information”) that may be used to generate one or more relationship maps and corresponding visuals as described in more detail below. Platform 4 may be operable to provide a user of a device 2a with content that may be displayed by, or on, an interface. In embodiments of the invention, information input by a user into a device 2a is communicated to the platform 4. Upon receiving this information, the platform 4 may be operable to use the received information to determine which attribute information should be retrieved from database 41 so that a relationship map and corresponding visuals can be generated, and eventually, sent on to a user device 2a.

The platform 4 and/or a user device 2a may be operable to also store the user data in a database 41 connected to, or associated with, platform 4 or a memory section within the platform 4, device 2a, or in a third-party database (not shown in figures). The user data and attribute information may be accessed as part of a process to provide a service to a user using the platform 4. The user data may be updated through communications exchanged by a given user device and platform, through communications received from other parts of the system 1, or from external sources (third party).

It should be understood that each of the physical embodiments of the system 1, platform 4, servers 42, devices 2a, 2b, . . . 2n and databases (e.g., database 41) their elements and other devices described herein are configured with the necessary electronics to enable each to process information much faster than humanly possible and to exchange information with each other much possible than humanly possible. Each of the embodiments of the present invention cannot practically be implemented in any amount of time that would be acceptable to one skilled in the art using human beings as substitutes for the systems, devices, databases and platforms described herein. For example, many of the embodiments described herein involve an exchange of information via a network between a physical user device and network device that are remotely located from one another, where the information exchanged must be available for immediate display to a user involved in the exchange of information. Accordingly, the speeds at which the information is exchanged, and the amount of information exchanged is many times faster than can be communicated and processed by the human mind. Nor can such information be displayed by the human mind or mechanical means (pen and paper) within the time periods demanded by users of the present invention and those skilled in the art of the present invention.

Unlike existing systems, the systems provided by the present invention are operable to receive a plurality of in-depth user data from users. For example, instead of simply receiving generalized information from a user, systems provided by the present invention may receive in-depth information from users in order to provide in-depth, simultaneous and instant visual interrelationships among many academic and career elements. By “instantly” is meant a period that is substantially short (no more than a few seconds) as measured by the perception of a user. By “simultaneous” is meant, at the same time as perceived by a user.

By way of a non-limiting example, one embodiment of the present invention provides for a platform 4 that is operable to analyze user data, such as the results of one or more scientifically valid academic and personality assessments (e.g., Holland Code based assessments, STEM or STEAM based assessments, personality and vocational assessments, etc.) and then generate a scientifically valid relationship map (hereafter “relationship map” or just “map”) based on the user data and attribute information, where the map may be represented as an array of elements. If valid scientific assessments results are used, the ensuing relationship map is then considered a scientifically valid relationship map, highly relevant to potential user academic and career paths.

In more detail, in one embodiment the platform 4 may be operable to receive assessments results and other user data from the user herself via device 2a, or indirectly from another source. Upon receiving such user data, the platform 4 may be operable to store the data in memory or database 41 and then analyze the user data in combination with attribute information to generate a relationship map. The relationship map generated by the platform 4 may include an array of elements, where certain elements are grouped into element types based on the fact that the elements in the group share a minimum set of common attributes (e.g., academic institutions are grouped together, academic majors are grouped together, occupations are grouped together and jobs are grouped together). Again, collectively, the grouped elements form an array that represents a relationship map. Upon generating a relationship map, the platform 4 may be operable to store the map in a memory or database 41. The map may be sent to a user device 2a, 2b, . . . 2n or may be retrieved by such a device.

It should be understood that there are many different types of elements over and above the examples set forth above and elsewhere herein. In accordance with embodiments of the invention, each element type is necessary, but not sufficient by itself, to develop an in-depth relationship map that will enable a user to reach a tangible goal. Said another way, existing systems typically only consider one of these element types. Thus, the information that is ultimately provided to the user is of little help in assisting the user in making an academic or career choice/decision. In addition, of the element types that are considered by existing systems, few attributes of each element are considered. Worse yet, existing systems present each element type independently of other element types to the user, even though each element type is at times deeply related to other types at many levels: there are associations, dependencies and non-dependencies (collectively referred to as “interrelationships” or “relationships” for short).

Accordingly, in embodiments of the present invention a relationship map may include a plurality of elements and element types, where each element may be associated with a plurality of different attributes. As a result, the relationship maps that are generated provide in-depth relationships between the many elements. In an embodiment of the invention, the platform 4, user device 2a or some combination of the same may be operable to generate data, based on a relationship map, that can be used to further generate one or more visualizations or visuals (hereafter “visuals” for short) of the relationship map. When generated by the platform 4, the data representative of a relationship map may be sent to a user device 2a for eventual display to a user on an interface of the device 2a. The generated visuals permit a user to instantly visualize the interrelationships between many elements, simultaneously. That said, it should be understood that each of the visuals described herein may be generated by the user device 2a based on data generated by the platform 4 which is sent to the user device 2a, 2b, . . . 2n.

It should be understood that to become eligible for inclusion in a particular element type, a specific element must have attributes that match, or are similar to, a minimum number of attributes that are shared by all elements of such a type. For example, to be eligible to be included into an academic institution element type, a given element must have the attributes that are shared by such institutions. The exact number of attributes that make up a minimal number of attributes may be varied by the platform 4 or user device 2a.

Referring to FIG. 2 there is depicted an exemplary visual 20 in accordance with one embodiment of the invention. Visual 20 includes a plurality of element types 21, 22 and 23. In the example shown in FIG. 2, each element type 21, 22, 23 includes a plurality of elements 21a-n, 22a-n and 23a-n, respectively (where “n” for all three element types represents the last element of an element type). More particularly in the exemplary visual in FIG. 2, each of the elements within an element type 21,22 and 23 share similar attributes (e.g., all the elements 21a-n of element type 21 are academic institutions, those making up element type 22 are majors/disciplines, and those making up element type 23 are occupations). It should be understood that the number of element types and the number of elements making up each type in FIG. 2 are merely exemplary. Said another way, the visual 20 represents a relationship map that is visualized as an array of elements grouped by element type. In the specific example in FIG. 2, the array is a 5 element by 3 element type array. However, in alternative embodiments the array may be a n×m array, where “n” is the number of elements (e.g., 5 in FIG. 2), and “m” is the number of element types (e.g., 5 in FIG. 2). Even more particularly, a fourth element type, called “jobs” and associated elements may be added to the array depicted in FIG. 2.

It should be further understood that the data used to generate the visual 20 (and all visuals described herein) may be retrieved from memory or a database (e.g., database 41) in the form of element related, attribute information and user data. By way of a non-limiting example, in one embodiment the platform 4 may be operable to retrieve attribute information that is related to four different types of element types, namely, academic institutions, academic majors, occupations and jobs from database 41. Depending on the user data that it receives from a user, or that it retrieves from database 41, the platform 4 may filter out certain elements from within each element type. For example, if the user data is assessment results, the platform 4 may compare the results to the attributes of the elements within the academic major element type, and only select those majors (elements) that are a “best fit” to the assessment results (e.g., the assessment shows a user is good in math, so the platform 4 selects engineering and science majors as the relevant elements within the “academic major” element type). Thereafter, the platform 4 may generate a relationship map that only (for example) includes those majors (elements) that best fit the assessment results, those academic institutions (another element type) that offer such a major, and those occupations and jobs (additional element types) that require such a major to qualify for such an occupation or job. In an embodiment of the invention, the platform 4 may further generate “links” between the elements within each element type. The so generated map may take the form of data stored within platform 4 (e.g., database 41 or a separate memory). Thereafter, the platform 4 may format the data representing the map into a form that may be transmitted to the user device 2a. Upon receiving such data, the user device 2a may be operable to generate the visual 20 in the form of an array of elements that are grouped into element types 21,22, 23 and connected by links, such as link 30.

In an alternative embodiment, rather than use assessment based user data to generate a relationship map, the platform 4 may use user preferences, or a combination of assessment data and user preferences that are provided to the platform 4. For example, a user of device 2a may send information to the platform 4 that identifies the attributes of an academic institution that she prefers (i.e., is interested in). Upon receiving this type of user data the platform 4 may retrieve data representing those academic institutions (elements) that best fit the provided user data from memory or database 41, along with data representing those academic majors (a second type of element) that offer such majors, those occupations (a third type of element) that require skills acquired by completing a course of study in such academic majors, and those jobs (a fourth type of element) that may be offered by employers within such occupations. Upon retrieving such data, the platform 4 may be operable to generate a relationship map based on the so retrieved data, and, thereafter, generate data representing a visual that includes an array of elements corresponding to the generated map.

Though the examples above utilize assessment results and user preferences as user data, it should be understood that other types of user data may be used. For example, preset or default user data may be used (e.g., if there are no assessments, and no user preferences, then a set of default user data may be used in conjunction with attribute information). Yet further, a set of data received from a third party, such as a consultant, advisor or another expert may be used.

In embodiments of the invention, regardless of the type of user data, the platform 4 may be operable to use any type of user data to select the proper attribute information from memory or database 41 that is associated with the user data (hereafter “attribute information”), where the attribute information may be further associated with elements, and element types, that will be thereafter be used to generate a relationship map that is configured as an array of elements.

Referring back to FIG. 2, though the visual in FIG. 2 is a two-dimensional array, it should be understood that a three-dimensional array may also be generated. In general, provided such an array can be visualized, a “p” dimensional array may be generated from data received from the platform 4, where the value of p is 1 or more.

Shown in FIG. 2 are interrelationship links 30 (hereafter “links”) connecting some of the elements (academic institutions) 21a-n to other elements (majors 22a-n). In accordance with embodiments of the invention, the links 30 represent the interrelationship(s) between an element of one type and an element of another, different type. These interrelationships are a part of the relationship map that has been generated by the platform 4, and depicted as visual 20. The nature of the interrelationships (attributes) between and among elements 21a-n and 22a-n (and 21a-n, 22a-n and 23a-n) is believed to be an important factor that influences the relevance of a path to user.

Each of the elements 21a-n, 22a-n and 23a-n may be referred to as a “node”. Thus, the relationship map that is represented by the visual 20 in FIG. 2 may be referred to as a “node view”. Collectively, the nodes form a network of a plurality of connected nodes, where all the nodes and their connections (links) are simultaneously visible in one visual.

The inventor believes that the ability to simultaneously view a plurality of links (relationships) between a plurality of elements is unique and greatly improves upon existing technology.

The exemplary visual 20 in FIG. 2 includes eight links 30. This is merely exemplary. In alternative embodiments, the number of links may be fewer or more than eight. In more detail, a plurality of links may be generated as a part of a visual.

In an embodiment, a series of connected interrelationship links may form a path (e.g., academic or career path). Thus, in accordance with an embodiment of the invention, a plurality of paths may be presented within a given visual. Again, the inventor believes that the ability to simultaneously present to a user a plurality of paths, presented in a visual form, almost instantaneously, is a substantial improvement over existing systems and methods that only provide one or a few paths.

Backtracking somewhat, as may be obvious to the reader, to generate a relationship map there needs to be at least two different types of elements (e.g., academic institutions and majors). That said, as indicated elsewhere herein, the present invention provides embodiments where “m” types of elements may form a relationship map and an associated visual.

One of the benefits provided by the relationship maps and visuals provided by the invention is that a user can visually see how one element relates to a plurality of other elements (e.g., how one major relates to a plurality of academic institutions and a plurality of occupations and jobs).

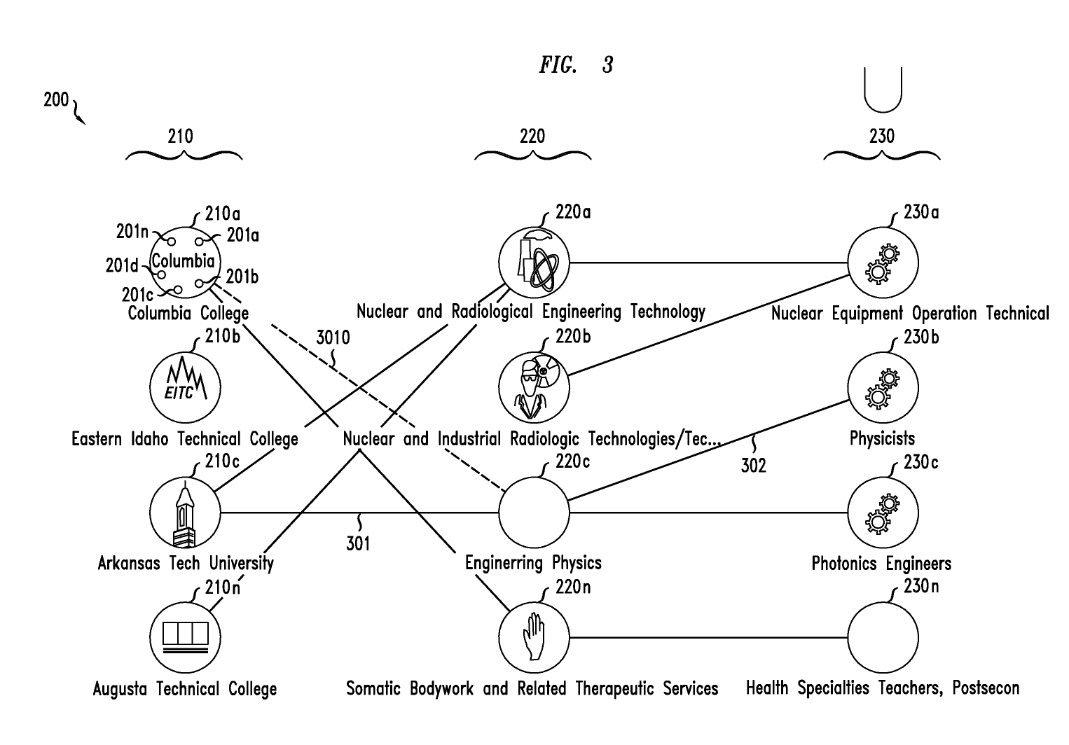

Referring to FIG. 3 there is depicted another visual 200 of an embodiment of the invention. As depicted, visual 200 includes an array that comprises a plurality of element types 210, 220 and 230 and respective elements or nodes 210a-n, 220a-n and 230a-n. The visual 200 also includes a plurality of interrelationship links, two of which are labelled 301,302. Together, links 301 and 302 form a path. As shown, FIG. 3 includes a plurality of paths formed by two links. The visual 200 may be generated using user data and attribute information, similar to how the visual 20 was generated.

In an embodiment of the invention, to generate the links 301, 302 the platform 4 (or user device 2a) provided by the present invention may be operable to compare the attributes of each element to the attributes of other elements (i.e., determine if the elements are related). If the attributes of each element are compatible, then the platform 4 may be operable to generate data that can be further used to generate a visual link between elements (e.g., create a link 301 between member 210c and 220c, and a link 302 between member 220c and 230b). Some examples of attributes associated with academic institutions (a first element type) are location, cost, total undergraduate class size, co-educational or not, degree of diversity of students, “open” campus or “gated” campus, science, technology, engineering and math (STEM) oriented or STEM plus liberal “arts’ (STEAM) liberal arts oriented). Attributes associated with academic majors (a second element type) include, for example, student/faculty ratio, fixed or flexible curriculum, practice oriented or theory oriented, number of credits required, class size, work-study availability, math, writing or laboratory intensive course, while attributes associated with occupations (a third element type) are outdoors or indoors job requirements/duties, white collar (salaried) or blue collar (hourly) compensation, physical requirements/duties versus mental requirements/duties, team oriented or individual oriented, number of alumni working in the occupation, and average salary. Yet further, attributes associated with jobs (a fourth element type) are the identity of potential employers, and the location of employers.

Within each element type there may be a plurality of individual elements. Further, the number of different attributes that can be associated with an element (or sub-element, described below) may be very large, such that a complete list of such attributes is practically impossible to present to the reader herein.

Also shown in FIG. 3 are sub-elements 201a to 201n (where “n” represents the last sub-element) that may be a part of element 210a. Though only element 210a is shown as including such sub-elements, it should be understood that any number of additional elements (including all elements in an array) may include sub-elements. Further, though element 210a is shown as including five sub-elements 201a through 201n, it should be understood that an element may include fewer or more sub-elements. Together, a group of sub-elements may form a “cluster”.

For example, element 210a is associated with “Columbia College”. In embodiments of the invention, sub-elements 201a through 201n may represent the various undergraduate schools that make up Columbia College, such as the School of Arts & Sciences, Engineering, Architecture, and Business school to name just a few of the many different sub-elements that are possible.

Further, similar to how links 301,302 are generated, the platform 4 may generate data representative of a sub-link 3010 between sub-element 3010 and an element 220c, or between sub-element 3010 and a sub-element of another element, for example, based on whether or not a sub-element 3010 shares compatible attributes with another sub-element or element of the elements/sub-elements within the array depicted as visual 200.

In FIGS. 2 and 3 the elements, sub-elements (nodes) are visually shown as geometric circles. This is exemplary. In alternative embodiments, each element or sub-element may be visually depicted in a number of different ways, such as: using different images, text, animation, video. Accordingly, the data generated by the platform 4 which is then sent to the use device 2a (or, alternatively, which is generated by the user device 2a itself) may further comprise data representative of image, textual, animation, video, or graphical information associated with one or more of the plurality of elements that is used to visually display such elements.

In each case, the visual representation of an element/sub-element is immediately identifiable by a user. In addition, rather than depict the interrelationships between each type of element or sub-element as links, the relationships may be depicted as other visual indicators and connectors that make it clear to the user that one element or sub-element is related to another.

In FIGS. 2 and 3 the element types represent, reading left to right, academic institutions, academic majors and occupations. In embodiments of the invention, it should be understood that either the platform 4 or user device 2a may be operable to change the configuration of the visuals 20,200 in FIGS. 2 and 3 by, for example, changing the position and/or sequence of element types. That is, instead of being arranged as just described the element types may be arranged as occupations first, followed by majors, followed by institutions (again, reading left to right). Said another way, the present invention provides the ability to change the sequence and position of element types within a visual array without changing the validity of the map (i.e., the map remains a scientifically valid relationship map). Accordingly, the relationship map generated by the platform 4 (e.g., spatial or visual structure) may correspondingly change as well, yet still remain a scientifically valid map. It should be understood that changing the configuration of the element and element types in a visual need not necessarily change a stored corresponding relationship map, however (i.e., just the visual is changed, not the map).

The ability to change the structure of a visual or relationship map is considered unique by the inventor. In embodiments of the invention many permutations (variations) of visuals and relationship maps may be generated by the platform 4 (or by a user device 2a) based on user data it receives or based on other data it receives, or based on input the user provides to her device 2a via an interface. Such permutations may include changing the position of an element type within an array (i.e., changing its column position) or changing the position of an element within an element type (i.e., changing its row to, for example, represent a most favorite institution on a top row and least favorite institution on a bottom row).

In addition to providing the ability to change a visual and a corresponding relationship map based on changing the configuration of the elements and element types, it should be understood that a map and its corresponding visuals may also be changed when the platform 4 or user device 2a receives additional user data and/or attribute information. Still further, the platform 4 or user device 2a may be operable to change a map and corresponding visual based on reference data related to a particular time or time period. For example, the platform 4 may store timing data that is updated continuously. Further, the stored user data and attribute information may be updated at set times or during set time periods based on the value of the timing data. In more detail, when the value of the timing data equals one year, the platform 4 (or user device 2a) may be operable to change, update or revise (collectively “update”) a user's stored relationship map and corresponding visuals to reflect the passage of one year's time. During the passage of a year's time, the attribute information may change because, for example, the information received from a number of different types of academic institutions, academic majors, occupations, jobs may change. These changes could affect the interrelationships between elements, and, therefore, change an associated relationship map and corresponding visual(s).

In embodiments of the invention, the visuals generated by the platform 4 or user device 2a may be stored by one, or both devices in their respective memories and databases (e.g., database 41) for later reference. This allows a relationship map and corresponding visuals to be retrieved for later reference and comparison. In addition, both the data that is used to generate a visual and the visual itself may exported to a different platform and processed there to unravel its constituent relationships. Yet further, either the platform 4 or user device 2a may generate a report that is based on the underlying data used to form a relationship map and its associated visuals. The report may be formatted and output via a printer, for example. It should be understood that the user device 2a may include a visual that includes an icon or another type of selector for storing a particular visual of particular interest to a user, essentially “freezing” a particular visual for storage and later retrieval.

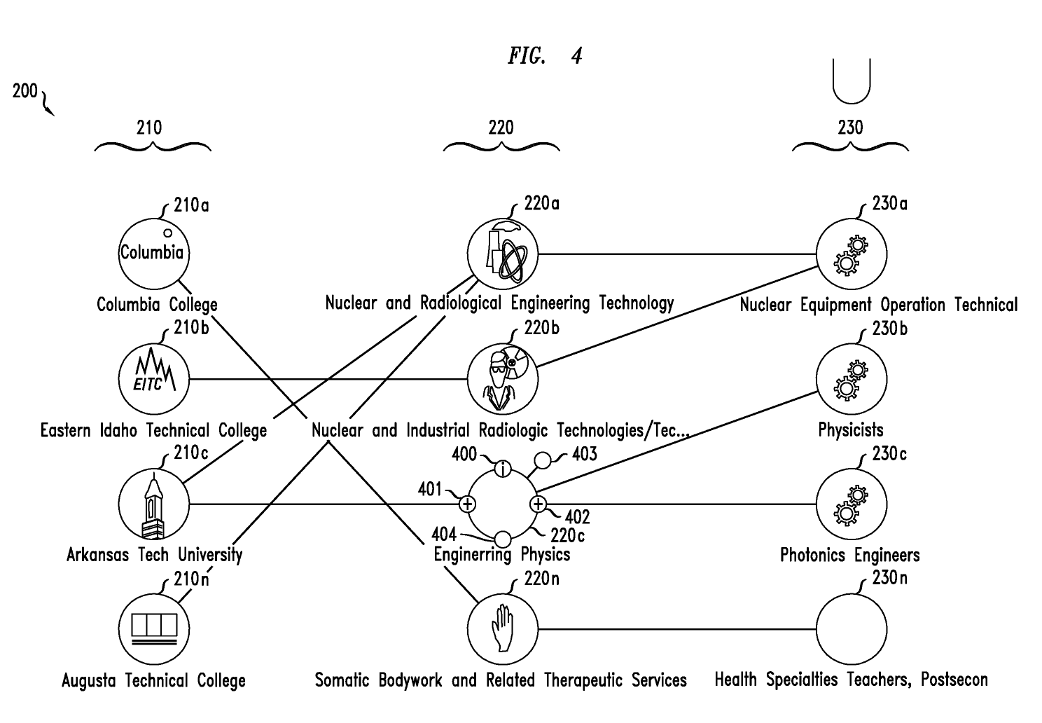

Referring now to FIG. 4 there is depicted an exemplary visual 2000 that includes similar element types and elements as in FIG. 3. The visual 2000 may be generated using user data and attribute information, similar to how the visual 20 (and 200) was generated.

In addition, however, visual 2000 includes an element 220c that includes one or more selectors 400,401, 402, 403 and 404. In an embodiment, selector 400 may be operable to provide a user with additional information pertaining to the element 220c. For example, the selector 400 may be clicked on, hovered over or otherwise selected (collectively “selected” or “selecting”). Once selected, the visual area associated with the selector 400 may change to display or otherwise reveal to the user additional information associated with the element 220c, such as a drop-down menu or list of attributes associated with the element, for example. Continuing, selector 401 may also be similarly selected by a user. As depicted in FIG. 4, an icon, such as a “+” may be used as a visual selector icon. In one embodiment, by selecting the selector 401a drop down menu or list of additional information may appear in the area associated with selector 401. For example, a drop-down menu of additional academic institutions may be presented to the user, where the additional institutions are similar to the institution associated with element 210c that is already linked to the academic major associated with element 220c. Said another way, by selecting selector 401 a user may visually see additional universities and colleges that are similar to a university or college that has already been linked to the academic major 220c. In an embodiment, these additional universities and colleges may represent those universities and colleges that offer the academic major represented by element 220c, namely, “Engineering Physics”.

Similarly, by selecting the selector 402, a drop-down menu or list of additional information may appear in the area associated with selector 402. For example, a drop-down menu of additional occupations may be presented to the user, where the additional occupations are similar to the occupation associated with element 230c that is already linked to the academic major 220c. Said another way, by selecting selector 402 a user may visually see additional occupations that are similar to occupation 230c that has already been linked to the academic major 220c. In an embodiment, these additional occupations may represent those occupations that are related to the academic major represented by element 220c, namely, “Engineering Physics”. Also shown in FIG. 4 is selector 403. In one embodiment upon selecting selector 403 the element (and sub-elements) 220c is designated as an element for special treatment. For example, all of the elements of visual 2000 may be removed except those element 220c that have been exempted from removal by selecting a selector 403. It should be understood that although element 220c is the only element depicted in FIG. 4 as including selectors 400 to 403 this is merely exemplary. One or more (e.g., all) of the elements included in the array displayed as visual 2000 may include such selectors.

Selector 404 may function as a user programmable selector operable to complete the functions of selectors 400 through 403, or additional functions, such as highlighting element 220c.

The visual 2000 also includes many links, such as link 301. In an embodiment, upon selection of the link 301 the area associated with the link 301 may include a visual depiction of additional information, such as a “comment” or “remarks” box, drop down menu or a list of the attributes of the elements 210c, 220c that are shared. Said another way, by selecting the link 301 the relationships and interrelationships shared by elements 210c and 220c may be displayed. For example, a remarks box that includes a sentence describing how the university associated with element 210c offers small class sizes for the linked academic major associated with element 220c.

Similar to selecting a link, in an alternative embodiment by selecting an element or a sub-element (using selector 400 for example) the area associated with the element or sub-element may include a visual depiction of additional information, such as a “comment” or “remarks” box, drop down menu or list of the attributes associated with the element. Said another way, by selecting an element or sub-element the attributes associated with such an element or sub-element may be displayed. For example, a list that includes attributes associated with an engineering physics degree may be displayed or a remarks box that includes a description of the types of courses a student (user) would typically be required to complete in order to receive an engineering physics undergraduate degree may be displayed. This allows a user to “drill down” into a specific element or sub-element to uncover information that characterizes, or provides more detailed information about, a particular element or sub-element. While the selectors are depicted as being a part of an element, it should be further understood that one or more of the selectors may also be a part of a sub-element.

FIG. 4 also depicts a path that comprises links 301, 302. In embodiments of the invention, the attributes of one of the elements 210c, 220c, 230b (or sub-elements) making up the path may be changed or adjusted by the user via user device 2a or by the platform 4. Thereafter, the platform 4 or user device 2a may be operable to generate data that may be used to display a revised relationship map in the form of a revised visual 2000 based on the changes made to the attributes. Thus, the generation of a path or link (i.e., whether a link or path will be generated at all, or, if generated, will persist) depends on both “direct” relationships between any two adjacent elements (or sub-elements) in an array (e.g., elements 210c and 220c, or 220c and 230b) but also on “indirect” relationships between any elements (or sub-elements) of the array. Said another way, if the attributes of element 230b are changed this may affect whether or not a direct link between it and element 220c is generated or persists after it is originally generated and may affect whether or not an indirect link between it and element 210c is generated or persists after it is originally generated.

Adjusting or changing the attributes of an element or sub-element is only one of many ways a relationship map and corresponding visual may be adjusted or changed. In an alternative embodiment, a plurality of filters may be applied to the user data and attribute information that is used to generate the relationship map, or applied to the array itself to limit or otherwise focus the visual on displaying only those elements, sub-elements, links and paths that are of most interest to a user. For example, a list of filters (not shown in the figures) may be presented to the user as a part of visual 2000 or a part of a visual that precedes visual 2000. By selecting a particular filter a particular element type or element may be selected or, alternatively, the number of element types and elements may be increased or decreased. Still further, unless an element type, element, or sub-element has been protected from being removed, or protected from being maximized or minimized (i.e., its contribution, or effect on, on a path is maximized or minimized) each of these can be individually or collectively removed, maximized or minimized by, for example, selecting the element (using selector 404, for example) by, for example, right clicking on a selection in a drop-down menu that says “delete”, “maximize”, “minimize” or adjust “weighting/contribution”. Similarly, if a user wishes to add an element type, element or sub-element into an array that does not already exist therein, the user can retrieve the respective type (by, for example, selecting selector 404), element or sub-element from a folder or the like and insert it into the array using any one of known functions, such “drag and drop” or “copy/cut and paste”. Thereafter, the so-inserted type, element and sub-element will become part of the relationship map. In an embodiment of the invention, the platform 4 and/or user device 2a may be operable to generate a revised relationship map that includes links and paths based on such insertions. These features and functions permit a user to explore the various relationships among a large number of element types in order to visually see potential relationships, interrelationships and paths. The removal, minimalization or maximizing (collectively “remove” or “removal”) of any one element within a path may render the end goal of the path (i.e., the last element in a path in an array) unattainable, or significantly more difficult to attain. For a user to gain a realization of this effect, it is important to provide the user with a visual view of all of the elements in a path, including a starting point (starting element), ending point (ending element) and all of the intermediate points (elements) in between, and allow the user to remove an element, or otherwise adjust the attributes of each element or interrelationships between elements to see the many different permutations of paths that result from such removals, and/or from similar adjustments or changes.

Accordingly, it should be understood a relationship map and its associated visuals may continuously evolve over time based on receipt of new or adjusted user data and attribute information.

In addition to the features and functions described above the present invention provides additional features and functions. For example, in one embodiment a user can select an element or sub-element and a detailed description of the element will be displayed by first selecting selector 404, or by simply selecting the element or sub-element itself. For example, by selecting element 210n detailed information about the academic institution associated with element 210n may be presented to the user. The information may be displayed as a drop-down menu, pop-up window, or an enlarged version of the pop-up window.

In addition to the embodiments set forth above, the present invention provides for embodiments that permit relationship maps generated by the platform 4 and its associated visuals to be shared (e.g., transmitted to, viewed by) explicitly or anonymously with other users or individuals. For example, a user may have spent a great amount of time generating a customized relationship map that includes specific academic institutions, majors and occupations. Thereafter, the user may realize that a number of other users (individuals) may be interested in the same institutions, majors and occupations (e.g., the other users have similar preferences or have received similar assessment results). Accordingly, the user may share his or her relationship map with another user or non-user (e.g., friend). More particularly, in one embodiment, a user may select a “save” icon displayed as a part of a visual to first save a visual of the relationship map to memory (e.g., a file folder) and then use any of a number of known methods to send or share the map with another individual. Alternatively, the user can select a “share” icon displayed as a part of a visual and immediately share the map with another individual. If a relationship map and its associated visuals become popular, the map may be shared with another individual in return for monetary consideration.

In addition to being shared, a relationship map may be embedded, or otherwise made a part of, another application, program, product or service.

It should be understood that although the relationship map generated by the platform 4 is represented as a node view in FIGS. 2 and 3, this is just one of the many types of views or visuals that may be generated.

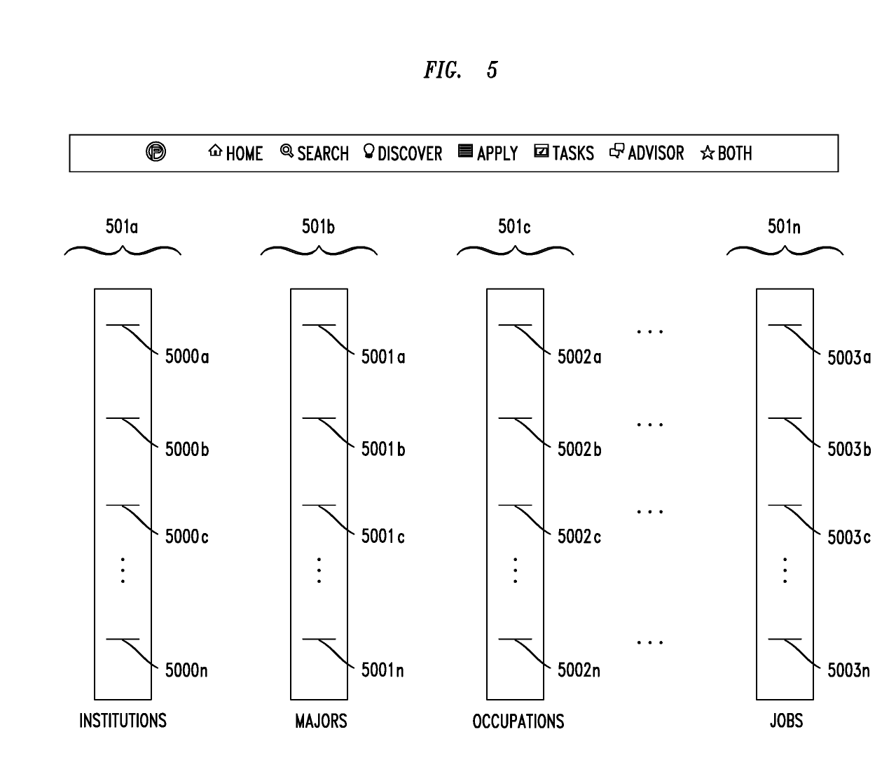

Referring now to FIG. 5 there is depicted one embodiment of a visual 500 that comprises a “list” view. As shown, the visual 500 comprises element types 501a to 501m, where “m” represents the last type of element type. Each element type comprises one or more elements. For example, element type 501a comprises elements 500a to 500n, where “n” is the last element within element type 501a. Further, though not shown in FIG. 5, it should be understood that each element may comprise one or more sub-elements. In an embodiment, to display such sub-elements a user may, for example, click on a particular element. The resulting area associated with the element would then display the sub-elements.

Similar to the visuals that are displayed as node views, the list view visual 500 comprises an array of elements, grouped together into element types (i.e., the element types are the columns and the elements are the rows).

Instead of displaying links as in the node view based visuals shown in FIGS. 2 through 4, in an embodiment of the invention the elements or sub-elements that are related to each other in visual 500 may be highlighted or otherwise visually distinguished from those elements that are not related to one another. For example, in response to a user clicking on element 5000a within element type 501a, one or more elements in one or more of the other element types 501b to 501m may thereafter be highlighted. Reading left to right, the highlighted or otherwise visually distinguishable elements are those that are related to one another.

Alternatively, rather than require a user to first select an element from one of the element types in order to cause other elements within different element types to be highlighted, visual 500 may include pre-selected elements that appear highlighted upon display of visual 500. Said another way, based on the user data and attribute information, the platform 4 (or user device 2a) may be operable to generate a relationship map that includes elements that are interrelated to one another. Further, platform 4 may be operable to generate data representing the relationship map, and additional data that is used to visually distinguish the so related elements. Such data may then be sent to user device 2a so that it can be displayed as visual 500.

It should be understood that highlighting related elements (or sub-elements) is just one method of visually distinguishing elements that are related to one another from those that are unrelated. Other methods comprise color-coding those elements or sub-elements that are related to one another using the same color, adding an indicator (e.g., an asterisk) next to each element or sub-element that are related, or surrounding each element that is related to one another with a geometric shape (e.g., circling each related element).

As described above, the related elements may be simultaneously highlighted. Alternatively, the elements within each element type may be highlighted in a certain sequence. For example, moving left to right, once element 5000a is selected, it may become highlighted and cause element 5001c to become highlighted as well. By then selecting element 5001c, element 5002a may become highlighted. This process may continue as the user moves from left to right until an element within each element type has been selected (provided, of course, there is an element within each element type that is related).

The highlighted elements form a visual path, much like the linked elements depicted in the node view of FIGS. 2 through 4 form a path.

Similar to the visuals that are displayed as node views in FIGS. 2-4, the configuration of visual 500 may be changed by changing the sequence of element types 501a to 501m. That is, instead of being arranged as shown the element types 501a to 501m may be arranged as job in the first column (as element type 501a) then occupations (as type 501b), followed by majors (as type 501c), and then institutions (as type 501m, again, reading left to right). According, the relationship map generated by the platform 4 would correspondingly change as well. As noted previously, the ability to change the structure of a relationship map by, for example, changing the sequence and position of element types within a visual array is considered unique by the inventor. In embodiments of the invention many permutations (variations) of relationship maps may be generated by the platform 4 (or by a user device 2a) based on user data it receives, based on other data it receives, or based on input the user provides to her device 2a via an interface. Such permutations may include changing the position of an element type within an array (i.e., changing its column position) or changing the position of an element within an element type (i.e., changing its row to, for example, represent a most favorite occupation on a top row and least favorite occupation on a bottom row). In sum, the platform 4 (or user device 2a) may be operable to change a configuration of an array making up a node view (FIGS. 2-4) or list view (FIG. 5), where the changes to such an array include corresponding changes to the interrelationships between the many element types and, therefore changes to links, included in the array. These changes further cause changes to academic or career paths that include the elements and links.

Similar to the node view based visuals in FIGS. 2-4, the list view visual 500 may be operable to provide a user with additional information pertaining to elements within the visual 500. For example, by double-clicking or right clicking on a given element or sub-element (e.g., an academic major) within visual 500 the visual area associated with the selected element/sub-element may change to display or otherwise reveal to the user additional information associated with the selected element, such as a drop-down menu or list of attributes associated with the element, for example. Alternatively, or in addition to such functions, a drop-down menu or list of additional academic institutions, majors, occupations or jobs may be presented to the user, where the additional institutions, occupations, majors and jobs are similar to an institution, occupation, major or job that is already highlighted (i.e., already related to the selected element). Said another way, by selecting a particular element a user may visual see additional elements that are similar to the element that is selected and/or similar to elements that are already been visually distinguished as being related to the selected element.

Similar to the visuals in FIGS. 2-4, in another embodiment by selecting (clicking on, or right clicking on) an element or sub-element the selected element or sub-element may be designated as an element for special treatment. For example, all of the elements of visual 500 may be removed except those elements that have been exempted from removal by their selection.

While exemplary embodiments have been shown, and described herein, it should be understood that variations of the disclosed embodiments may be made without departing from the spirit of the invention.

The claims that follow are intended to cover the exemplary embodiments described herein along with any equivalents of such embodiments. In all cases the words used in the claims should be interpreted to render the claims valid over any prior art.

1. A system for visualizing interrelationships in academic or career paths comprising:
a hardware platform operable to,
generate data, representing one or more visuals, based on a scientifically-valid relationship map that comprises interrelationships between a plurality of element types related to one or more academic or career paths, and
send the generated data to a user device; and
a user device operable to receive
the one or more visuals and visually display the interrelationships between the many element types related to the one or more academic or career paths.

2. The system as in claim 1 wherein each element type further comprises a plurality of elements, wherein each element of a same element type shares a minimum number of similar attributes.

3. The system as in claim 2 wherein the generated data further comprises data representative of image, textual, animation, video, or graphical information associated with one or more of the plurality of elements.

4. The system as in claim 1 wherein the plurality of element types comprise academic institutions, academic majors, occupations and jobs.

5. The system as in claim 2 wherein one or more of the elements of an element type comprises one or more sub-elements.

6. The system as in claim 5 wherein one of the visuals further comprises a plurality of links connecting at least one of the elements or sub-elements of one of the element types to at least one element or sub-element of another element type, wherein the link represents interrelationships between the connected elements or sub-elements.

7. The system as in claim 2 wherein the one visual further comprises links that form a path.

8. The system as in claim 7 wherein each path comprises an academic or career path.

9. (canceled)

10. The system as in claim 1 wherein the platform is further operable to generate data representing one of the one or more visuals, the data representing an array of the element types.

11. The system as in claim 1 wherein the platform or the user device are operable to change a configuration of the array, the changed array comprising corresponding changes to the interrelationships between the many element types related to the one or more academic or career paths.

12. (canceled)

13. The system as in claim 1 wherein the platform is further operable to operable to change a configuration of one or more of the visuals by changing a position/or sequence of element types within the element types.

14. The system as in claim 1 wherein the platform is further operable to change the map and the one or more visuals based on reference data related to a particular time or time period.

15. A method for visualizing interrelationships in academic or career paths comprising:
generating data, by a hardware platform, representing one or more visuals, based on a scientifically-valid relationship map that comprises interrelationships between many element types related to one or more academic or career paths; and
sending the generated data to a user device from the hardware platform,
receiving the the one or more visuals at a user device, and
visually displaying the interrelationships between the many element types related to the one or more academic or career paths.

16. The method as in claim 15 wherein each element type further comprises a plurality of elements, wherein each element of a same element type shares a minimum number of similar attributes.

17. The method as in claim 15 wherein the generated data further comprises data representative of image, textual, animation, video, or graphical information associated with one or more of the plurality of elements.

18. The method as in claim 15 wherein the plurality of element types comprise academic institutions, academic majors, occupations and jobs.

19. The method as in claim 16 wherein one or more of the elements of an element type comprises one or more sub-elements.

20. The method as in claim 19 wherein one of the visuals further comprises a plurality of links connecting at least one of the elements or sub-elements of one of the element types to at least one element or sub-element of another element type, wherein the link represents interrelationships between the connected elements or sub-elements.

21. The method as in claim 16 wherein the one visual further comprises links that form a path.

22. The method as in claim 21 wherein each path comprises an academic or career path.

23. (canceled)

24. The method as in claim 15 further comprising generating data representing one of the one or more visuals, the data representing an array of the element types, using the platform.

25. The method as in claim 24 further comprising changing a configuration of the array, the changed array comprising corresponding changes to the interrelationships between the many element types related to the one or more academic or career paths, using the platform or the user device.

26. (canceled)

27. The method as in claim 15 further comprising changing a configuration of one or more of the visuals by changing a position/or sequence of element types within the element types using the platform.

28. The method as in claim 15 further comprising changing the map and the one or more visuals based on reference data related to a particular time or time period using the platform.
